(19) United States
(12) Patent Application Publication
(10) Pub. No.: US 2011/0215139 A1
(43) Pub. Date: Sep. 8, 2011

(54) PREPAID CARD LOAN MECHANISM AND METHODS OF COMPLETING TRANSACTIONS AND TRANSFORMING GOODS

(75) Inventors: Michael A. Herold, Buffalo Grove, IL (US); Allen C. Franks, Mena, AR (US); Kirk James Humphrey, White Lake, MI (US); Keith E. Byrd, Milford, MI (US)

(73) Assignee: Money Service Centers, LLC, Southfield, MI (US)

(21) Appl. No.: 12/718,215

(22) Filed: Mar. 5, 2010

(51) Int. Cl. G06Q 40/00

(52) U.S. Cl. 235/379

(57) ABSTRACT

Loan mechanisms for completing transactions made with prepaid cards where an insufficient balance exists on the prepaid card to complete the transaction, methods of completing transactions for an amount that exceeds an available balance on a prepaid card, and methods of transforming goods from a state of being retail inventory to a state of being owned by and in the possession of an end user. Loan mechanisms may include a website, a database, a connection to at least one prepaid card authorization machine, programmed technology to evaluate whether to make a loan, an apparatus to add funds to the card sufficient to cover the transaction, and a collection feature for collecting the loaned funds plus compensation. Methods may include acts of collecting information, perceiving a transaction attempt for an amount that exceeds an available balance, evaluating consent, evaluating credit risk, loaning money, and later collecting from the card holder.

### FIELD OF THE INVENTION

This invention relates to prepaid card systems, loan mechanisms, methods of completing transactions for an amount that exceeds an available balance on a prepaid card, and methods of transforming goods from a state of being retail inventory into a state of being owned and in the possession of an end user.

### BACKGROUND OF THE INVENTION

A number of different cards have been used to conduct transactions instead of cash, including credit cards, debit cards, and prepaid cards, as examples. Prepaid cards have been used to complete transactions where sufficient balance existed on the card to complete the transaction, and in so doing, goods purchased have been transformed from a state of being retail inventory into a state of being owned and in the possession of an end user.

In the prior art, however, if a prepaid card holder attempted to purchase goods that exceeded the available funds on the prepaid card, the card processor issued an “Insufficient Funds” decline message and the transaction was not completed. As a result, card holders who wanted to purchase goods were unable to do so, merchants who wanted to sell the goods were not able to do so, and the issuing bank lost interchange on the lost sale. In addition, card holders have been both frustrated and embarrassed in such situations, and merchants have had to restock goods as inventory that otherwise would have been sold, often to the would-be end user.

For these and other reasons, needs or potential for benefit exist for loan mechanisms for completing transactions made with prepaid cards that provide for completion of the transaction even where an insufficient balance exists on the prepaid card. In addition, needs or potential for benefit exist for methods of completing transactions for an amount that exceeds an available balance on a prepaid card. Furthermore, needs or potential for benefit exist for particular methods of transforming goods under such circumstances from a state of being retail inventory to a state of being owned by or in the possession of an end user.

Room for improvement exists over the prior art in these and other areas that may be apparent to a person of ordinary skill in the art having studied this document. Other needs and potential for benefit may also be apparent to a person of skill in the art of prepaid card systems, loan mechanisms, methods of completing transactions for an amount that exceeds an available balance on a prepaid card, or methods of transforming goods from a state of being retail inventory into a state of being owned and in the possession of an end user, as examples.

### SUMMARY OF PARTICULAR EMBODIMENTS OF THE INVENTION

Various embodiments provide, for example, as an object or benefit, that they partially or fully address or satisfy one or more of the needs, potential areas for benefit, or opportunities for improvement described herein, or known in the art, as examples. Some embodiments of the invention provide, among other things, various loan mechanisms, methods of completing transactions for an amount that exceeds an available balance on a prepaid card, or methods of transforming goods, for instance, from a state of being retail inventory into a state of being owned and in the possession of an end user, as examples.

A number of embodiments provide, for example, as objects or benefits, adaptations and improvements to loan mechanisms, methods of completing transactions, or methods of transforming goods, as examples. Benefits of various embodiments of the invention exist over the prior art in these and other areas that may be apparent to a person of ordinary skill in the art having studied this document. These and other aspects of various embodiments of the present invention may be realized in whole or in part in various embodiments as shown, described, or both, in the figures and related description herein. Other objects and benefits may also be apparent to a person of skill in the art of prepaid cards, for example.

In specific embodiments, this invention provides, for example, various loan mechanisms for completing transactions made with prepaid cards where an insufficient balance exists on the prepaid card to complete the transaction. In a number of embodiments, such a loan mechanism may include, for example, a website, a database, a connection to at least one prepaid card authorization machine, programmed technology created to evaluate whether to make loans, an apparatus to add funds to the prepaid card, and a collection feature, for instance. Such a website may have at least one data gathering feature, for example, to gather information concerning the ACH direct deposit history of prepaid card holders who visit the website. Further, the database may be, for instance, to store the information concerning the ACH direct deposit history, or a credit score derived therefrom, as examples, for multiple of the prepaid card holders who visit the website.

Further still, the connection to at least one prepaid card authorization machine may include, for example, a trigger to contact the loan mechanism when an authorization for a transaction is requested in situations in which the prepaid card holder does not have sufficient funds applied to the prepaid card to complete the transaction. Even further, the programmed technology mentioned above may use the information in the database to evaluate whether to loan a prepaid card holder an amount, for instance, sufficient to cover a balance deficiency for the transaction, when the prepaid card holder does not have sufficient funds applied to the prepaid card to complete the transaction. Moreover, the apparatus to add funds may add funds to the prepaid card sufficient to cover the balance deficiency. In a number of embodiments, the apparatus may be configured to add the funds in real time during the transaction without interrupting the transaction, for example. Further still, the collection feature, in a number of embodiments, may collect from the prepaid card holders funds that have been added to their prepaid cards, for instance, to cover the balance deficiencies.

In particular embodiments, the collection feature of such a loan mechanism may include, for instance, an arrangement to collect from multiple prepaid cards when funds are next applied to the card. In some embodiments, the collection feature may include an arrangement to collect from prepaid cards when funds are direct deposited from an employer of the prepaid card holder, for instance. Further, in specific embodiments, the collection feature may include, for example, an arrangement to collect a fee for making each loan, for example, as well as recovering funds that have been added to the prepaid cards to cover the balance deficiencies. Further, in certain embodiments, the website may include, for example, at least one consent gathering feature, for example, to obtain consent from multiple card holders who visits the website to borrow funds sufficient to cover a balance deficiency on their prepaid card. Moreover, in some embodiments, the website may include, for instance, at least one consent gathering feature to obtain consent from multiple card holder who visit the website. The consent provided may be to pay a fee to borrow funds, for example.

The invention also provides various methods, for example, tied to a prepaid card authorization machine, of completing transactions for an amount that exceeds an available balance on a prepaid card. Various embodiments of such methods may include, for example (e.g., in various orders) at least certain acts. Such acts may include, for instance, an act of, for instance, using at least one specially-programmed computer, collecting information concerning multiple prepaid card holders. In certain embodiments, the information may include, for example, credit worthiness information, consent from the prepaid card holders to borrow money if the available balance on a prepaid card is exceeded, and consent from the prepaid card holders to be charged compensation for the borrowing of the money, as examples.

In a number of embodiments, such acts may also include receiving, from the prepaid card authorization machine, for instance, an indication when a prepaid card holder has attempted to initiate a transaction using a prepaid card for an amount that exceeds an available balance on the prepaid card. Such methods may also include, for further example, using at least one specially-programmed computer, for instance, an act of evaluating whether the prepaid card holder has provided the consent to borrow money and the consent to be charged compensation for the borrowing of the money, as examples.

Yet another act that may be included is an act of (e.g., using at least one specially-programmed computer) evaluating whether the prepaid card holder is a good credit risk for lending, for instance, a difference between the amount of the transaction and the available balance. If the prepaid card holder is a good credit risk (e.g., for lending the difference between the amount of the transaction and the available balance), such a method may include (e.g., using at least one specially-programmed computer), an act of loaning the prepaid card holder at least the difference between the amount of the transaction and the available balance. In various embodiments, such an act may be performed in real time such that the prepaid card authorization machine completes the transaction without interruption, for example. Such methods may further include, for instance (e.g., using at least one specially-programmed computer), a further act of later collecting from the prepaid card holder the difference between the amount of the transaction and the available balance plus the compensation.

In particular embodiments, the act of collecting information from multiple prepaid card holders may be performed using a website and in some embodiments, at least a portion of the information collected may be stored on a computer-readable storage medium, for example. Further, in some embodiments, the method may further include, for instance, an act of advertising (e.g., the opportunity to obtain a loan) to prepaid card holders. Such advertising may include, for example, instructing prepaid card holders to go to the website and enter the information. Further, in a number of embodiments, the loaning may include, for instance, adding funds to the prepaid card. Moreover, in certain embodiments, after the loaning is completed, the computer (e.g., at least one specially-programmed computer) may resubmit the transaction as if the transaction was being processed for the first time, such that the authorization machine sees that there are enough funds applied to the prepaid card and authorizes the transaction.

In certain embodiments, the act of collecting from the prepaid card holder (e.g., the difference between the amount of the transaction and the available balance plus the compensation) may include, for instance, electronically collecting funds from the prepaid card, for example, after the funds are later applied to the card. Moreover, in some embodiments, the act of lending the difference between the amount of the transaction and the available balance may include, for instance, transforming the prepaid card from a first state, having a first available balance, to a second state, having a second available balance, for example.

Other examples of methods that the invention provides include various methods specifically of transforming goods from a state of being retail inventory to a state of being owned by, and in the possession of, an end user. Such methods may include, for example (e.g., in the following order), at least the particular acts of evaluating consent, making the loan, and collecting for the loan. Specifically, when a prepaid card holder has attempted to pay for a transaction using a prepaid card, and the transaction is for an amount of money that exceeds an available balance on the prepaid card, in various embodiments, an act may be performed of evaluating whether the prepaid card holder has provided consent to borrow money and, in a number of embodiments, to be charged compensation for the borrowing of the money. Further, if the prepaid card holder has provided the consent, such a method may include using a computer to loan the prepaid card holder at least a difference between the amount of the transaction and the available balance. In many embodiments, this may be done in real time such that the transaction is completed without interruption, for example. Further, such methods may include an act of later collecting from the prepaid card holder the difference between the amount of the transaction and the available balance, for instance, plus the compensation.

In particular embodiments, for example, the goods may include food and the food may be transformed from one state into another by the user eating the food. Moreover, in some embodiments, the act of using a computer to loan the prepaid card holder (e.g., at least) the difference between the amount of the transaction and the available balance may include, for instance, transforming the prepaid card from one state to another by changing the available balance on the prepaid card. Further, in certain embodiments, for example, before the act of evaluating whether the prepaid card holder has provided consent to borrow money and to be charged compensation for the borrowing of the money, such a method may include an act of collecting information from multiple prepaid card holders, for instance. Such information may include, for example, consent to borrow money if the available balance on a prepaid card is exceeded, consent to be charged compensation for the borrowing of the money, or both. Further, in various embodiments, the information may include, for example, credit worthiness information. In certain embodiments, for example, the act of using a computer to loan the prepaid card holder at least the difference between the amount of the transaction and the available balance is performed only if the prepaid card holder is a good credit risk.

In addition, various other embodiments of the invention are also described herein.

### BRIEF DESCRIPTION OF THE DRAWINGS

FIG. 1 is a block diagram illustrating, among other things, a loan mechanism for completing transactions made with prepaid cards where an insufficient balance exists on the prepaid card to complete the transaction; and

FIG. 2 is a flow chart illustrating examples of acts that may be found in a method (e.g., tied to a prepaid card authorization machine), of completing transactions for an amount that exceeds an available balance on a prepaid card, or a method of transforming goods, for example, from a state of being retail inventory to a state of being owned by and in the possession of an end user.

The drawings illustrate, among other things, various examples of embodiments of the invention, certain examples of characteristics thereof, and examples of environments in which different embodiments of the invention may be used. Different embodiments of the invention include various combinations of elements or acts shown in the drawings, described herein, known in the art, or a combination thereof, for instance.

### DETAILED DESCRIPTION OF EXAMPLES OF EMBODIMENTS

Among other things, various embodiments are, include, obtain, or provide various loan mechanisms, methods of completing transactions for an amount that exceeds an available balance on a prepaid card, or methods of transforming goods, for instance, from a state of being retail inventory into a state of being owned and in the possession of an end user, as examples. Multiple embodiments provide a line of credit that provides a service or fills a need for prepaid card holders in an open-loop prepaid card market. Particular embodiments include third party add-on features, for example, for processors and program managers of prepaid cards to offer to their card holders. Examples of such processors and program managers of prepaid cards, or card networks, may include popular brands of cards such as MasterCard, VISA, Discover, and American Express, for instance. In a number of embodiments, the third party loan provider may have an agreement with the card processor or network processor, for example. Other embodiments may not involve such a third party, however, and may be performed by the processors or program managers of the prepaid cards, as other examples. In various embodiments, consumers may purchase goods or services (or both) using their branded prepaid card, even when they do not currently have the funds available on their cards to support the transaction.

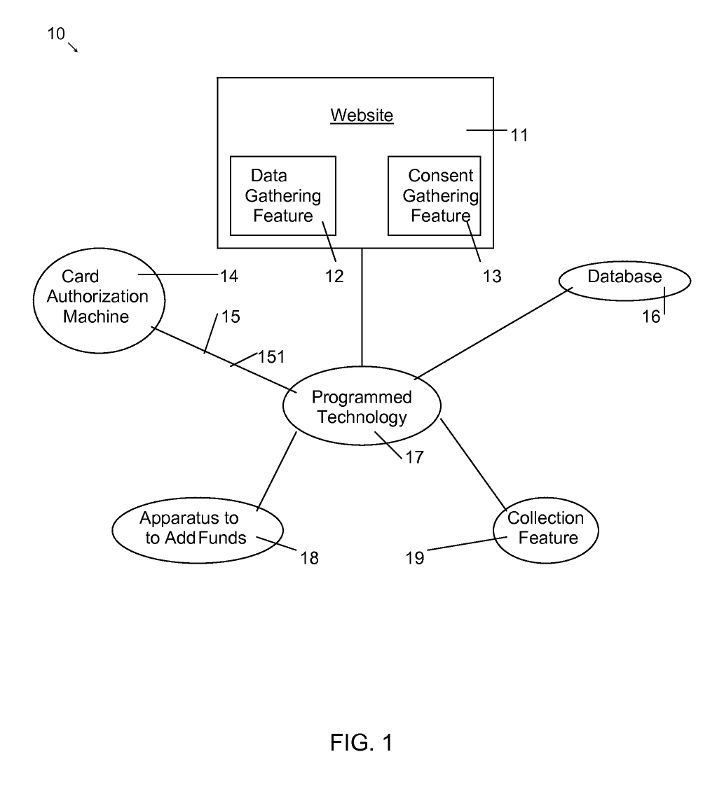

FIG. 1 illustrates, for example, loan mechanism 10 for completing transactions made with prepaid cards where an insufficient balance exists on the prepaid card to complete the transaction. In the embodiment illustrated, loan mechanism 10 includes, for example, website 11, database 16, connection 15 to prepaid card authorization machine 14, programmed technology 17, apparatus 18 to add funds to the prepaid card, and collection feature 19, for instance. In this embodiment, website 11 is an opt-in website and includes data gathering feature 12 for example, to gather information concerning the Automated Clearing House (ACH) history (e.g., direct deposit history) of prepaid card holders who visit website 11. Website 11 may collect information about each card holder or customer (e.g., name, address, phone, date of birth, employer, pay scale, pay frequency, prepaid card number, etc.) to make business decisions concerning whether to accept applicants into the program (e.g., to receive loans via apparatus 18).

Further, database 16, in this embodiment, may be, for instance, used to store the information (e.g., concerning the ACH direct deposit history, or a credit score derived therefrom), for multiple of the prepaid card holders who visit website 11. In some embodiments, if accepted into the program, a card holder may be assigned a “credit amount”, for example, based on various rules and calculations that may be used. Website 11, and database 16, for instance, may be located or hosted on a computer or a server, for example. Website 11 may be accessible via the Internet, for example. In different embodiments, website 11 and database 16 may be hosted on the same or different servers, or one or more of website 11 and database 16 may be hosted on multiple servers in some embodiments.

Other embodiments may have multiple connections (e.g., similar to 15) to multiple card authorization machines (e.g., 14), for instance, for different prepaid cards issued by different companies. In the embodiment illustrated, connection 15 to (e.g., at least one) prepaid card authorization machine 14 includes, for example, trigger 151 to contact loan mechanism 10 (e.g., via programmed technology 17) when an authorization for a transaction is requested (e.g., by a prepaid card holder or a merchant engaged in a sale thereto) in situations in which the prepaid card holder does not have sufficient funds applied to the prepaid card to complete the transaction. Even further, in the embodiment illustrated, programmed technology 17 may use information in database 16, for example, to evaluate whether to loan a prepaid card holder an amount, for instance, sufficient to cover a balance deficiency for the transaction, when the prepaid card holder does not have sufficient funds applied to the prepaid card to complete the transaction.

In the embodiment shown, apparatus to add funds 18 may add funds to the prepaid card, for example, sufficient to cover the balance deficiency. In a number of embodiments, apparatus 18 may be configured to add the funds in real time during the transaction (e.g., a transaction performed using card authorization machine 14) without interrupting the transaction, for example. Further still, in the embodiment illustrated, collection feature 19 collects from the prepaid card holders funds that have been added to their prepaid cards, for instance, to cover the balance deficiencies. In particular embodiments, collection feature 19 of loan mechanism 10 may include, for instance, an arrangement to collect from multiple prepaid cards, or from each prepaid card, when funds are next applied to the card. In some embodiments, collection feature 19 may include an arrangement to collect from prepaid cards when funds are direct deposited, for example, to the card, for instance, from an employer of the prepaid card holder. In a number of embodiments, prepaid card holders may receive direct deposits from other sources instead, or in addition thereto, such as government assistance, Social Security, a trust fund, etc. In various embodiments, such deposits may be reoccurring (e.g., at regular intervals), may be predictable, or both, as examples.

Further, in specific embodiments, collection feature 19 may include, for example, an arrangement to collect a fee for making (e.g., each) loan, for example, as well as for recovering funds that have been added to the prepaid cards (e.g., by apparatus 18) to cover the balance deficiencies. Further, in the embodiment illustrated, website 11 includes, for example, (e.g., at least one) consent gathering feature 13, for example, to obtain consent from multiple (or from each) card holder who visits website 11. Such consent (e.g., gathered in consent gathering feature 13) may be or include consent to borrow funds (e.g., to be later added by apparatus 18), for instance, sufficient to cover a balance deficiency on the prepaid card. Moreover, in some embodiments, website 11 or consent gathering feature 13 may obtain consent from multiple card holders who visit the website. Such consent (e.g., obtained by feature 13) may include consent to pay a fee to borrow funds, for example.

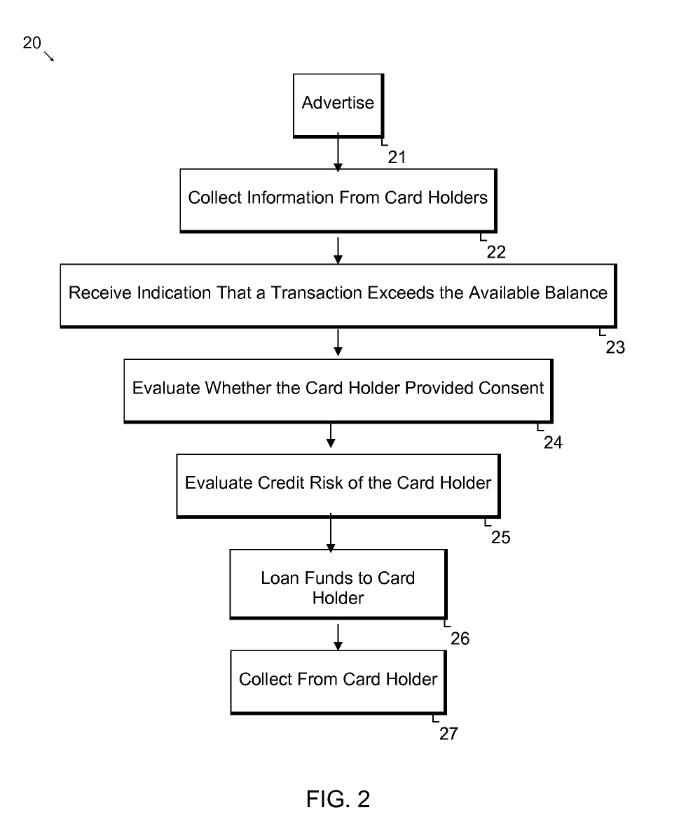

FIG. 2 illustrates various embodiments that are or include particular methods, for example, tied to a prepaid card authorization machine (e.g., 14). Method 20 is an example of a method of completing transactions for an amount that exceeds an available balance on a prepaid card. Various embodiments of such methods may include, for example, (e.g., in various orders) at least certain acts, a number of which are shown, as examples. Such acts may include, for instance, act 22 of (e.g., using at least one specially-programmed computer), collecting information concerning multiple prepaid card holders. Act 22 may be performed using website 11, for example. In certain embodiments, the information (e.g., collected in act 22, for instance, via website 11) may include, for example, credit worthiness information (e.g., collected in act 22 via data gathering feature 12), consent (e.g., collected in act 22 via consent gathering feature 13) from the prepaid card holders to borrow money if the available balance on a prepaid card is exceeded, consent (e.g., collected in act 22 via consent gathering feature 13) from the prepaid card holders to be charged compensation for the borrowing of the money, or a combination thereof, as examples. In particular embodiments, at least a portion of the information collected (e.g., in act 22) may be stored on a computer-readable storage medium, for example (e.g., database 16).

In third party systems, the number of the card may be collected (e.g., in act 22), and the system (e.g., loan mechanism 10 or programmed technology 17) may evaluate whether the card number received is associated with a processor or card network (e.g., associated with card authorization machine 14) that has contracted to offer the loan service (e.g., via loan mechanism 10). If not, in some embodiments, a message may be sent back via the website (e.g., 11) to have the customer or card holder contact their HR department, for example, to request the service. In some such embodiments, documentation may be provided to the card holder, for instance, to print off, to provide to their HR department to facilitate obtaining the service. In particular embodiments, if the card is associated with a processor that has contracted to offer the service (i.e., to make loans available to card holders, for instance, via loan mechanism 10), the card holder may be notified (e.g., via website 11) whether they have been accepted in to the program or declined (e.g., based on their credit worthiness, for instance, based on information collected in act 22, for example, via data gathering feature 12). In certain embodiments, card holders who have been accepted may be notified (e.g., via website 11) how much credit they have been extended, for example.

In a number of embodiments, such acts (e.g., of method 20) may also include act 23 of receiving (e.g., from prepaid card authorization machine 14, for instance, via connection 15), an indication when a prepaid card holder has attempted to initiate a transaction using a prepaid card for an amount that exceeds an available balance on the prepaid card. Such methods (e.g., 20) may also include, for further example (e.g., using at least one specially-programmed computer), act 24 of evaluating whether the prepaid card holder has provided the consent (e.g., collected in act 22, for instance, via consent gathering feature 13) to borrow money and the consent (e.g., also collected in act 22, for instance, via consent gathering feature 13) to be charged compensation for the borrowing of the money, as examples.

Another act that may be included in different embodiments (e.g., of method 20) is act 25 of (e.g., using at least one specially-programmed computer, using programmed technology 17, or both) evaluating whether the prepaid card holder is a good credit risk for lending a difference between the amount of the transaction and the available balance. If the prepaid card holder is a good credit risk for lending the difference between the amount of the transaction and the available balance (e.g., as evaluated in act 25), such a method (e.g., method 20) may include (e.g., using at least one specially-programmed computer, using apparatus to add funds 18, or both), act 26 of loaning the prepaid card holder at least the difference between the amount of the transaction and the available balance.

In some embodiments, the amount loaned (e.g., in act 26) may be precisely the difference between the amount of the transaction and the available balance. On the other hand, in other embodiments, the amount loaned (e.g., in act 26) may be more than the difference between the amount of the transaction and the available balance. For instance, in some embodiments, ten dollars may be loaned (e.g., in act 26) if the difference between the amount of the transaction and the available balance is more than zero, and yet no more than ten dollars, for example. In other embodiments, the amount loaned (e.g., in act 26) may be the difference between the amount of the transaction and the available balance, rounded up to the next whole dollar, or to the next greater multiple of five dollars, as further examples. In various embodiments, such an act or acts (e.g., at least act 26) may be performed in real time such that the prepaid card authorization machine (e.g., 14) completes the transaction without interruption, for example.

In the embodiment illustrated, method 20 further includes, for instance (e.g., using at least one specially-programmed computer, collection feature 19, or both), a further act 27 of later collecting from the prepaid card holder the difference between the amount of the transaction and the available balance (e.g., loaned in act 26) plus the compensation (e.g., consented to in act 22 and evaluated in act 24). Further, in some embodiments, method 20 may further include, for instance, act 21 of advertising (e.g., the opportunity to obtain a loan, loan mechanism 10, or method 20) to prepaid card holders. Such advertising (e.g., in act 21) may include, for example, instructing prepaid card holders to go to the website (e.g., 11) and enter the information (e.g., collected in act 22). In a number of embodiments, card holders may find out about the opportunity to obtain loans (e.g., loan mechanism 10 or method 20) through their prepaid cards, through marketing and announcements (e.g., advertising in act 21) made by the program manager or network (e.g., MasterCard). In some embodiments, these announcements or marketing (e.g., advertising in act 21) may be made through the card holder's employer or payroll service, as examples, that may announce the availability of the (e.g., new) service, for instance.

Further, in a number of embodiments, the loaning (e.g., in act 26) may include, for instance, adding funds to the prepaid card (e.g., using apparatus to add funds 18). Moreover, in certain embodiments, after the loaning (e.g., in act 26) is completed, the computer (e.g., at least one specially-programmed computer, such as loan mechanism 10 or programmed technology 17) may resubmit the transaction (e.g., to or via card authorization machine 14) as if the transaction was being processed for the first time, such that the authorization machine (e.g., 14) sees that there are enough funds applied to the prepaid card and authorizes the transaction. On the other hand, in other embodiments, the balance may be checked, the funds may be added, and the transaction may be submitted the first time (i.e., without a resubmit, for example, just based on the balance, without an actual “Insufficient Funds” decline message).

In certain embodiments, act 27 of collecting from the prepaid card holder (e.g., the difference between the amount of the transaction and the available balance plus the compensation) may include, for instance, electronically collecting funds from the prepaid card, for example, after the funds are later applied to the card. Collection feature 19 may be used, for instance. Moreover, in some embodiments, act 26 of lending, for example, the difference between the amount of the transaction and the available balance, may include, for instance, transforming the prepaid card from a first state, having a first available balance (e.g., insufficient to perform the transaction), to a second state, having a second available balance (e.g., sufficient to perform the transaction), for example.

FIG. 2 and method 20 also illustrates other examples of methods including various methods specifically of transforming goods from a state of being retail inventory to a state of being owned by and in the possession of an end user, for example. Such methods (e.g., method 20) may include, for example (e.g., in the following order), at least the particular acts of evaluating consent (e.g., act 24), making the loan (e.g., act 26), and collecting for the loan (e.g., act 27). Specifically, when a prepaid card holder has attempted to pay for a transaction using a prepaid card, and the transaction is for an amount of money that exceeds an available balance on the prepaid card, in various embodiments, act 24 may be performed of evaluating whether the prepaid card holder has provided (e.g., through website 11, in act 22, or both) consent (e.g., via consent gathering feature 13) to borrow money (e.g., in act 26) and, in a number of embodiments, to be charged compensation (e.g., in act 27) for the borrowing of the money.

Further, if the prepaid card holder has provided the consent (e.g., in act 22, via consent gathering feature 13, or both), such a method (e.g., 20) may include (e.g., using a computer, programmed technology 17 apparatus to add funds 18, or a combination thereof) to loan (e.g., in act 26) to the prepaid card holder, for instance, at least a difference between the amount of the transaction and the available balance. In many embodiments, this (e.g., act 26) may be done in real time such that the transaction is completed without interruption, for example. Further, such methods (e.g., 20) may include an act (e.g., 27) of later collecting from the prepaid card holder, for example, the difference between the amount of the transaction and the available balance, in many embodiments, plus the compensation.

In particular embodiments, for example, the goods may include food and the food (e.g., that a card holder purchases as via method 20) may be transformed from one state into another by the user (e.g., card holder, customer, or end user) eating the food. As used herein, beverages are considered to be a type of food. Moreover, in some embodiments, the act of using a computer (e.g., using programmed technology 17) to loan (e.g., in act 26) the prepaid card holder (e.g., at least) the difference between the amount of the transaction and the available balance may include, for instance, transforming the prepaid card from one state to another by changing the available balance on the prepaid card (e.g., in act 26, for instance, from a lower balance insufficient to support the transaction to a higher balance that is sufficient).

Further, in certain embodiments, for example, before act 24 of evaluating whether the prepaid card holder has provided consent to borrow money and to be charged compensation for the borrowing of the money, for example, such embodiments of method 20 may include act 22 of collecting information from multiple prepaid card holders, for instance. Such information (e.g., collected in act 22, for instance, via website 11) may include, for example, consent to borrow money if the available balance on a prepaid card is exceeded, consent to be charged compensation for the borrowing of the money, or both (e.g., collected via consent gathering feature 13, evaluated in act 24, or both). Further, in various embodiments, the information (e.g., collected in act 22) may include, for example, credit worthiness information (e.g., gathered using data gathering feature 12). In certain embodiments, for example, act 26 of loaning (e.g., using a computer to loan) the prepaid card holder at least the difference between the amount of the transaction and the available balance is performed only if the prepaid card holder is a good credit risk (e.g., as evaluated in act 25).

In various embodiments, a prepaid card holder (e.g., a regular prepaid MasterCard) may bring goods to a cashier in a place of business (e.g., a store). The cashier may ring up the merchandise and the card holder may hand the cashier the prepaid card. The cashier may then swipe the prepaid card at a card reader (e.g., card authorization machine 14) and the processor (e.g., the MasterCard processor, or card authorization machine 14) may then check the available balance on the prepaid card and see that there are not enough funds available for the transaction. In the past, the processor would have sent the transaction back with an “Insufficient Funds” or non-sufficient funds (NSF) decline message. In such a situation, the customer (i.e., the prepaid card holder) would be embarrassed, and would walk away without the goods or services. In addition, the merchant would loose the sale and would have to restock the items. Furthermore, the card network (e.g., MasterCard) and issuing bank would loose interchange on the lost sale.

In a number of embodiments of the invention, however, the processor (e.g., the MasterCard processor, or card authorization machine 14) electronically “asks”, for example, programmed technology 17 (e.g., the third party credit provider, for instance, via link 15) if they would like to make a loan to the customer (e.g., the prepaid card holder) in order to make the transaction successful. This act of asking may involve providing the “indication” that the transaction exceeds the available balance of act 23, for example. The credit provider, loan mechanism 10, or programmed technology 17, as examples, may then (e.g., after acts 24 and 25 of checking for consent and evaluating credit risk, but in real time from the perspective of the customer an the merchant), provide an affirmative response (e.g., approving the loan) and may load the additional or necessary funds onto the customer's prepaid card (e.g., via apparatus to add funds 18), for example.

In some embodiments, the transaction may then be resubmitted (e.g., through or to card authorization machine 14), for instance, as if it were being submitted or processed for the first time. The processor (e.g., card authorization machine 14 or the MasterCard processor) may then check the balance on the card and see that there are enough funds on the card. As a result, the processor may then send the transaction back with a “Successful” or “Approved” message, allowing the transaction to be completed as if there had been more funds on the card all along. In such embodiments, the customer is happy and walks away with the goods, the merchant sells the goods and makes a profit, and the processor (e.g., MasterCard) and issuing bank get interchange on the sale.

In many embodiments, card holders may be able to use their payment method (e.g., prepaid card) in the same or substantially the same manner as they normally would. In other words, from a purchasing experience standpoint, there may be no visible difference between a transaction involving an embodiment of the invention (e.g., loan mechanism 10 or method 20) and one that does not, from either the customer's point of view or that of the cashier. In some embodiments, this will be the case for automatic teller machine (ATM) transactions as well as point of sale (POS) transactions. In some embodiments, however, a card holder may not be able to get an amount of cash (e.g., from an ATM) that exceeds the balance on the card.

In a number of embodiments each transaction requiring a loan will deduct the amount of the loan (e.g., made in act 26) for that transaction from the total credit limit of the card holder until the credit limit has been exhausted. In some embodiments, upon the card holder's next deposit, or next direct deposit, for example, the money loaned (e.g., through apparatus to add funds 18), as well as any applicable fees, may be debited from the card (e.g., by collection feature 19, for instance, via card authorization machine 14, for example, in act 27). Upon such collection, the card holder's credit limit may be restored to the original credit limit, for example.

Further, in a number of embodiments, the settlement of a transaction may be the same for the merchant as any other transaction (e.g., made with a similar prepaid card). Since real money may be loaded onto the card behind the scenes when the loan was made (e.g., in act 26, via apparatus to add funds 18, or both), the merchant may experience no changes to their existing settlement procedures. In some embodiments, a daily ACH withdrawal may be made from the third party's (e.g., loan mechanism 10's) bank account, for example, and paid to the program manager's card holder funding account (CFA), for instance, to make the CFA whole for their prepaid program. At some point in the future, the card holder's direct deposit, for example, will occur, and the processor will debit the prepaid card for the money that was loaned and any applicable fees (e.g., in act 27, via collection feature 19, or both). In various embodiments, daily reporting for reconciliation may be provided, for example. In a number of embodiments that involve a third party (e.g., providing loan mechanism 10), the third party (e.g., the lender, for instance, rather than the card processor or the merchant) may be responsible for financial losses due to loans that have been made to card holders that are unable to be collected (e.g., in act 27), for example, through direct deposit reclamation.

In some embodiments, card holders may be able to access their transaction history, view monthly fees, view how much money they have borrowed, view their credit limit, print monthly statements, and administer their account through the Internet (e.g., via website 11), for example. In particular embodiments, such information may be available to card holders, for example, by calling a toll-free number, for instance, by entering their card number and a password, for example, through an Interactive Voice Response (IVR) system, via text messaging (e.g., SMS, for instance, using a mobile phone), or both, as examples. In some embodiments, particular or key program metrics, reporting, card holder information, settlement and return item amounts, other MIS statistics, or a combination thereof, may be made available, for example, to designated employees (e.g., of the third party) through the processor.

The various components shown in the different drawings, described herein, or both, may be found in various combinations in different embodiments. Other embodiments may be apparent to a person of ordinary skill in the art having studied this document, and may include features or limitations described herein, shown in the drawings, or both. Various methods may include part or all of the acts shown in FIG. 2, described herein, or known in the art, as examples.

What is claimed is:

1. A loan mechanism for completing transactions made with prepaid cards where an insufficient balance exists on the prepaid card to complete the transaction, the loan mechanism comprising:
a website having at least one data gathering feature to gather information concerning the ACH direct deposit history of prepaid card holders who visit the website;
a database to store the information concerning the ACH direct deposit history, or a credit score derived therefrom, for multiple of the prepaid card holders who visit the website;
a connection to at least one prepaid card authorization machine, the connection comprising a trigger to contact the loan mechanism when an authorization for a transaction is requested in situations in which the prepaid card holder does not have sufficient funds applied to the prepaid card to complete the transaction;
programmed technology created to use the information in the database to evaluate whether to loan a prepaid card holder an amount sufficient to cover a balance deficiency for the transaction when the prepaid card holder does not have sufficient funds applied to the prepaid card to complete the transaction;
an apparatus to add funds to the prepaid card sufficient to cover the balance deficiency wherein the apparatus is configured to add the funds in real time during the transaction without interrupting the transaction; and
a collection feature to collect from the prepaid card holders funds that have been added to their prepaid cards to cover the balance deficiencies.

2. The loan mechanism of claim 1 wherein the collection feature comprises an arrangement to collect from multiple prepaid cards when funds are next applied to each of the multiple prepaid cards.

3. The loan mechanism of claim 1 wherein the collection feature comprises an arrangement to collect from a prepaid card when funds are direct deposited from an employer of the prepaid card holder.

4. The loan mechanism of claim 1 wherein the collection feature comprises an arrangement to collect a fee for making each loan as well as recovering funds that have been added to the prepaid cards to cover the balance deficiencies.

5. The loan mechanism of claim 1 wherein the website comprises at least one consent gathering feature to obtain consent from multiple card holders who visit the website to borrow funds sufficient to cover a balance deficiency on their prepaid card.

6. The loan mechanism of claim 1 wherein the website comprises at least one consent gathering feature to obtain consent from multiple card holders who visits the website, wherein the consent is provided to pay a fee to borrow funds.

7. A method, tied to a prepaid card authorization machine, of completing transactions for an amount that exceeds an available balance on a prepaid card, the method comprising in any order at least the acts of:
using at least one specially-programmed computer, collecting information concerning multiple prepaid card holders, the information comprising:
credit worthiness information;
consent from the prepaid card holders to borrow money if the available balance on a prepaid card is exceeded; and
consent from the prepaid card holders to be charged compensation for the borrowing of the money;
receiving from the prepaid card authorization machine, an indication when a prepaid card holder has attempted to initiate a transaction using a prepaid card for an amount that exceeds an available balance on the prepaid card;
using at least one specially-programmed computer, evaluating whether the prepaid card holder has provided the consent to borrow money and the consent to be charged compensation for the borrowing of the money;
using at least one specially-programmed computer, evaluating whether the prepaid card holder is a good credit risk for lending a difference between the amount of the transaction and the available balance;
if the prepaid card holder is a good credit risk for lending the difference between the amount of the transaction and the available balance, using at least one specially-programmed computer, loaning the prepaid card holder at least the difference between the amount of the transaction and the available balance in real time such that the prepaid card authorization machine completes the transaction without interruption; and
using at least one specially-programmed computer, later collecting from the prepaid card holder the difference between the amount of the transaction and the available balance plus the compensation.

8. The method of claim 7 wherein the act of collecting information from multiple prepaid card holders is performed using a website and wherein at least a portion of the information collected is stored on a computer-readable storage medium.

9. The method of claim 8 wherein the method further comprises an act of advertising the loaning to prepaid card holders, wherein the advertising includes instructing prepaid card holders to go to the website and enter the information.

10. The method of claim 7 wherein loaning comprises adding funds to the prepaid card wherein after the loaning is completed, the at least one specially-programmed computer resubmits the transaction as if the transaction was being processed for the first time, such that the authorization machine sees that there are enough funds applied to the prepaid card and authorizes the transaction.

11. The method of claim 7 wherein the act of collecting from the prepaid card holder the difference between the amount of the transaction and the available balance plus the compensation comprises electronically collecting funds from the prepaid card after the funds are later applied to the card.

12. The method of claim 7 wherein the act of lending the difference between the amount of the transaction and the available balance comprises transforming the prepaid card from a first state, having a first available balance, to a second state, having a second available balance.

13. A method of transforming goods from a state of being retail inventory to a state of being owned by and in the possession of an end user, the method comprising in the following order at least the acts of:
when a prepaid card holder has attempted to pay for a transaction using a prepaid card, and the transaction is for an amount of money that exceeds an available balance on the prepaid card, evaluating whether the prepaid card holder has provided consent to borrow money and to be charged compensation for the borrowing of the money;
if the prepaid card holder has provided the consent, using a computer to loan the prepaid card holder at least a difference between the amount of the transaction and the available balance in real time such that the transaction is completed without interruption; and
later collecting from the prepaid card holder the difference between the amount of the transaction and the available balance, plus the compensation.

14. The method of claim 13 wherein the goods comprise food and the food is transformed from one state to another by the user eating the food.

15. The method of claim 13 wherein the act of using a computer to loan the prepaid card holder at least the difference between the amount of the transaction and the available balance comprises transforming the prepaid card from one state to another by changing the available balance on the prepaid card.

16. The method of claim 13 further comprising, before the act of an act of evaluating whether the prepaid card holder has provided consent to borrow money and to be charged compensation for the borrowing of the money, an act of collecting information from multiple prepaid card holders, the information comprising consent to borrow money if the available balance on a prepaid card is exceeded, and consent to be charged compensation for the borrowing of the money.

17. The method of claim 13 further comprising, before the act of an act of evaluating whether the prepaid card holder has provided consent to borrow money and to be charged compensation for the borrowing of the money, an act of collecting information from multiple prepaid card holders, the information comprising credit worthiness information.

18. The method of claim 13 further comprising, before the act of using a computer to loan the prepaid card holder at least the difference between the amount of the transaction and the available balance, an act of evaluating whether the prepaid card holder is a good credit risk for lending a difference between the amount of the transaction and the available balance, and wherein the act of using a computer to loan the prepaid card holder at least the difference between the amount of the transaction and the available balance is performed only if the prepaid card holder is a good credit risk.
